(19) United States
(12) Patent Application Publication
(10) Pub. No.: US 2017/0169190 A1
(43) Pub. Date: Jun. 15, 2017

(54) HEALTH COACHING SYSTEM BASED ON USER SIMULATION

(71) Applicant: KONINKLIJKE PHILIPS N.V., EINDHOVEN (NL)

(72) Inventors: AKI SAKARI HÄRMÄ, EINDHOVEN (NL); ILLAPHA GUSTAV LARS CUBA GYLLENSTEN, STOCKHOLM (SE)

(21) Appl. No.: 15/373,566

(22) Filed: Dec. 9, 2016

Related U.S. Application Data
(60) Provisional application No. 62/265,440, filed on Dec. 10, 2015.

(51) Int. Cl. G06F 19/00; G06Q 10/10

(52) U.S. Cl. CPC G06F 19/3481; G06Q 10/109

(57) ABSTRACT

In an embodiment, an apparatus (36) is presented that establishes a cost to the subject in performing physical activity during time segments of plural types of subject behavior for one or more days of his or her daily routine and simulates scenarios that are used to provide a health plan (110) that best changes a physiological parameter over a projected period of time while minimizing a total cost to the subject.

### CROSS-REFERENCE TO RELATED APPLICATIONS

This patent application claims the priority benefit under 35 U.S.C. §119(e) of U.S. Provisional Application No. 62/265,440 filed on Dec. 10, 2015, the contents of which are herein incorporated by reference.

### FIELD OF THE INVENTION

The present invention is generally related to health management, and more specifically, to health coaching based on the activity tracking and other recorded data.

### BACKGROUND OF THE INVENTION

A large variety of activity trackers, such as physical activity trackers, is being offered on the market. Such activity trackers may be worn as a bracelet or wristband, and include one or more sensors ranging from a single accelerometer to additional sensors such as heart rate sensors. Typically, the activity tracker is accompanied with an application in a smartphone or other electronics device that provides a dashboard associated with the recorded activity and some data-driven coaching. For instance, EP2363061A1 describes a sensor device preferably worn by a user on his or her body and adapted to generate signals in response to physiological characteristics of the user as well as data about the surrounding environment. The data is periodically uploaded to a remote central monitoring unit via an intermediary device (e.g., a personal computer or wireless device), where it is stored for subsequent processing and presentation to the user. Energy balance predictions are performed, and suggestions are provided in the form of intermittent status reports to the user that convey compliance by the user to achieve a preset goal, acknowledgement and praise for the user when he or she has achieved the preset goal, or general suggestions on achieving the goal for the day based on the energy balance predictions when data indicates more calories consumed than what is projected to be burned.

### SUMMARY OF THE INVENTION

One object of the present invention would be to provide a health plan that reduces the noise of too many options by providing a limited number of concrete opportunities to improve the health of the subject while minimizing the inconvenience to the subject. To better address such concerns, in a first aspect of the invention, an apparatus is presented that establishes a cost to the subject in performing physical activity during time segments of plural types of subject behavior for one or more days of his or her daily routine and simulates scenarios that are used to provide a health plan that best changes a physiological parameter over a projected period of time while minimizing a total cost to the subject.

In an embodiment, the processing circuit is configured to determine the health plan by: determining a physical activity energy expenditure for each day of the predetermined period of time based on the physical activity; estimating a time series of expected measurements of the physiological parameter for the projected period of time based on a total energy expenditure determined from the physical activity energy expenditure and nutritional intake, the projected period of time using the pattern of behavior of the predetermined period of time; re-computing the total energy expenditure and a revised cost for the physical activity for each day of the projected time period using the plural simulated scenarios that modify the pattern of behavior of the predetermined period of time with additional periods of the physical activity; and estimating the time series of forecasted measurements of the physiological parameter for the projected period of time based on the re-computed total energy expenditures and the revised costs. The total energy expenditure, which is based on the physical activity energy expenditure, user information, and macronutrient intake, are used in one of any plurality of computational models that provide a reliable prediction of changes to a monitored physiological parameter, such as weight or body fat, to provide the time series of expected measurements. In other words, the time series of expected measurements correspond to a baseline simulation using historical patterns of behavior of the user and projected over time. The total energy expenditure and costs can be re-computed based on scenarios of simulations that modify the amount of physical activity and when the activity is modified in a manner that attempts to achieve the most gain in improving the user's health with the least cost, and hence providing a concrete and concise plan without the inefficiencies of other systems.

In an embodiment, the plural types of behavior comprise one or any combination of a sleep behavior, a morning behavior, a first commute behavior, a work behavior, a second commute behavior, and an evening behavior. By segmenting each day based on the behavior of the subject, a framework can be established for determining when it is convenient or inconvenient to add additional physical activity during each day or select days of the week as opposed to a more non-specific plan to generally increase physical activity.

In an embodiment, the costs are pre-defined, estimated from responses from the subject, based on a questionnaire or interview of the subject, or based on any combination of the predefinition, responses, questionnaire and interview. Recognizing the value in establishing a cost by one or a combination of various mechanisms enables a realization of a cost component in deriving a health plan as opposed to an inefficient trial and error approach to finding a time most suitable for adding the physical activity.

In an embodiment, a processing circuit of the apparatus is configured to determine additional health plans as well as the health plan as options for selection, the additional health plans corresponding to the series of forecasted measurements of the physiological parameter that minimizes the total cost for the physical activity while maximizing the health benefit associated with the physiological parameter. The presentation of additional options allows the subject more options in choosing among optimized plans, as opposed to a more generalized approach to health plans.

In an embodiment, feedback is provided that comprises a trajectory of values for the physiological parameter and associated cost over the projected period of time, enabling the subject to have a clear indication as to how and on what time scale a particular concrete change in behavior influences a physiological parameter.

These and other aspects of the invention will be apparent from and elucidated with reference to the embodiment(s) described hereinafter.

### BRIEF DESCRIPTION OF THE DRAWINGS

Many aspects of the invention can be better understood with reference to the following drawings, which are diagrammatic. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram that illustrates an example environment in which a health coaching system is used in accordance with an embodiment of the invention.

FIG. 2 is a block diagram that illustrates circuitry for an example wearable device in accordance with an embodiment of the invention.

FIG. 3A is a block diagram that illustrates a processing circuit for an example computing device in accordance with an embodiment of the invention.

FIG. 3B is a schematic diagram that illustrates an example data structure of recorded and derived data stored by the computing device of FIG. 3A in accordance with an embodiment of the invention.

FIGS. 4A-4C are schematic diagrams that graphically illustrate an example process and, optionally, feedback in which the computing device generates recorded and derived data in accordance with an embodiment of the invention.

FIGS. 5A-5D are schematic diagrams that illustrate example processing and feedback provided by the computing device based on simulated scenarios in accordance with an embodiment of the invention.

FIG. 6 is a flow diagram that illustrates a health coaching method in accordance with an embodiment of the invention.

### DETAILED DESCRIPTION OF EMBODIMENTS

Disclosed herein are certain embodiments of a health coaching system and method that provide an optimized health plan or plans based on simulated interventions. For instance, based on analysis over a predetermined period of time of recorded lifestyle or behavioral pattern sensor data or other input data from a subject (e.g., user), a computational model is estimated that represents health-related lifestyle behavior of the user with meaningful, semantic categories or types of behavior. The model may be used to synthesize similar data and, using computational models of physiological parameter(s), a forecast of the effects of changes in the lifestyle behavior on the physiological parameter(s) is generated from the simulated data. The health coaching system automatically determines a health plan that is optimal in terms of cost and health benefits, reducing, if not removing, sub-optimal choices from the user's health plan.

Digressing briefly, health planning based on setting targets and agreeing on non-specific behavior modifications, such as increasing an activity or changing diet, is not very motivating and transparent for users. In current health planning services, there is no clear indication on how, and on which time scale, a particular concrete change in the lifestyle of an individual user influences the physiological target parameters. For example, a user whom may want to reduce weight may be given general advice and hints on how to become more active. If the user then decides to pick up a particular healthy habit, such as bicycling to work instead of taking a car, the current health programs have no mechanisms to show how this particular habit will help the user to reach the target weight and how long and regularly this habit must be practiced for it to be effective. Therefore, conventional health programs (both with human coaches and e-coaches) are likely to lead to an unnecessary waste of the time, mental, and physical resources of the users in learning and maintaining behaviors that may have little or no influence on the actual desired health change. In contrast, certain embodiments of a health coaching system simulate scenarios that are used to provide a health plan or a constrained number of plans that best lead to improvements in one or more physiological parameters (e.g., weight, body fat) over a projected period of time while minimizing a total cost to the subject, enabling a concise and concrete health plan.

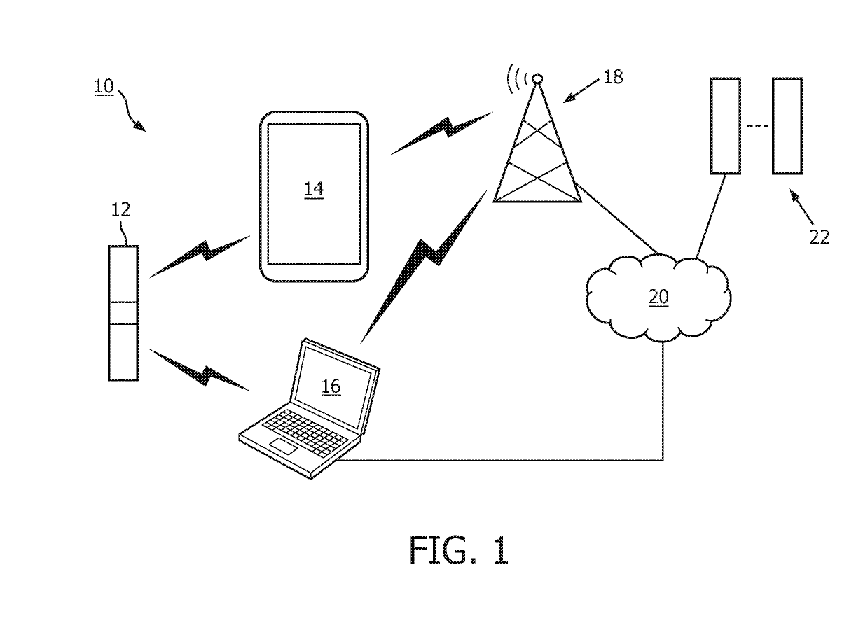

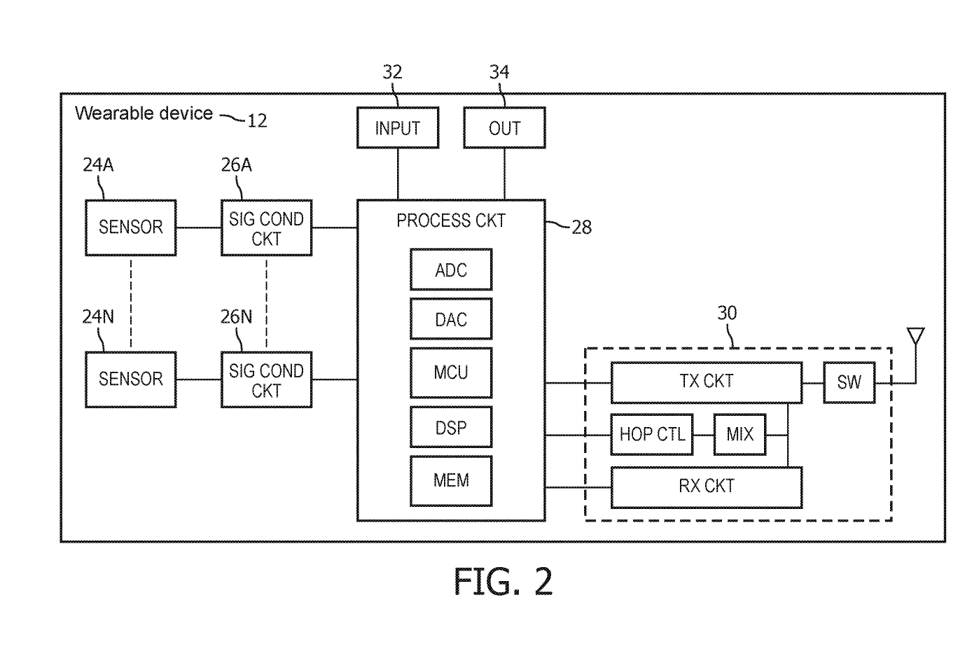

Attention is directed to FIG. 1, which illustrates an example environment 10 in which a health coaching system is used in accordance with an embodiment of the invention. It should be appreciated by one having ordinary skill in the art in the context of the present disclosure that the environment 10 is one example among many, and that some embodiments of a health coaching system may be used in environments with fewer, greater, and/or different components that those depicted in FIG. 1. The environment 10 comprises a plurality of devices that enable communication of information throughout one or more networks. The depicted environment 10 comprises a wearable device 12, electronics devices 14, 16, a cellular network 18, a wide area network 20 (e.g., also described herein as the Internet), and a remote computing system 22. The wearable device 12, as described further in association with FIG. 2, is typically worn by the subject (e.g., around the wrist), and comprises a plurality of sensors that track physical activity of the subject (e.g., steps, swim strokes, pedaling strokes, etc.), sense or derive physiological parameters (e.g., heart rate, respiration, skin temperature, etc.) based on the sensor data, and optionally sense various other parameters (e.g., outdoor temperature, humidity, location, etc.) pertaining to the surrounding environment of the wearable device 12. A representation of such gathered data may be communicated to the subject via an integrated display on the wearable device and/or on another device or devices.

Also, such data gathered by the wearable device 12 may be communicated (e.g., continually, periodically, and/or aperiodically) to one or more electronics devices, such as the electronics devices 14 and 16. Such communication may be achieved wirelessly (e.g., using near field communications (NFC) functionality, Blue-tooth functionality, etc.) and/or according to a wired medium (e.g., universal serial bus (USB), etc.). In the depicted example, the electronics device 14 is embodied as a phone and the electronics device 16 is embodied as a computer. It should be appreciated that although each electronics device is listed in the singular, some implementations may utilize different quantities for each of the electronics devices 14, 16. Further, in some embodiments, fewer, additional, and/or other types of electronics devices may be used. The phone 14 may be embodied as a smartphone, mobile phone, cellular phone, pager, among other handheld computing/communication devices with telephony functionality. For the sake of example, assume the phone 14 is embodied as a smartphone. The smartphone 14 comprises at least two different processors, including a baseband processor and an application processor. The baseband processor comprises a dedicated processor for deploying functionality associated with a protocol stack, such as a GSM (Global System for Mobile communications) protocol stack. The application processor comprises a multi-core processor for providing a user interface and running applications. The baseband processor and application processor have respective associated memory (e.g., random access memory (RAM), Flash memory, etc.), peripherals, and a running clock.

More particularly, the baseband processor may deploy functionality of a GSM protocol stack to enable the smartphone 14 to access one or a plurality of wireless network technologies, including WCDMA (Wideband Code Division Multiple Access), CDMA (Code Division Multiple Access), EDGE (Enhanced Data Rates for GSM Evolution), GPRS (General Packet Radio Service), Zigbee (e.g., based on IEEE 802.15.4), Bluetooth, Wi-Fi (Wireless Fidelity, such as based on IEEE 802.11), and/or LTE (Long Term Evolution), among variations thereof and/or other telecommunication protocols, standards, and/or specifications. The baseband processor manages radio communications and control functions, including signal modulation, radio frequency shifting, and encoding. The baseband processor may comprise a GSM modem having one or more antennas, a radio (e.g., RF front end), and analog and digital baseband circuitry. The RF front end comprises a transceiver and a power amplifier to enable the receiving and transmitting of signals of a plurality of different frequencies, enabling access to the cellular network 18. The analog baseband is coupled to the radio and provides an interface between the analog and digital domains of the GSM modem. The analog baseband comprises circuitry including an analog-to-digital converter (ADC) and digital-to-analog converter (DAC), as well as control and power management/distribution components and an audio codec to process analog and/or digital signals received from the smartphone user interface (e.g., microphone, earpiece, ring tone, vibrator circuits, etc.). The ADC digitizes any analog signals for processing by the digital baseband processor. The digital baseband processor deploys the functionality of one or more levels of the GSM protocol stack (e.g., Layer 1, Layer 2, etc.), and comprises a microcontroller (e.g., microcontroller unit or MCU) and a digital signal processor (DSP) that communicate over a shared memory interface (the memory comprising data and control information and parameters that instruct the actions to be taken on the data processed by the application processor). The MCU may be embodied as a RISC (reduced instruction set computer) machine that runs a real-time operating system (RTIOS), with cores having a plurality of peripherals (e.g., circuitry packaged as integrated circuits) such as RTC (real-time clock), SPI (serial peripheral interface), I2C (inter-integrated circuit), UARTs (Universal Asynchronous Receiver/Transmitter), devices based on IrDA (Infrared Data Association), SD/MMC (Secure Digital/Multimedia Cards) card controller, keypad scan controller, and USB devices, GPRS crypto module, TDMA (Time Division Multiple Access), smart card reader interface (e.g., for the one or more SIM (Subscriber Identity Module) cards), timers, and among others. For receive-side functionality, the MCU instructs the DSP to receive, for instance, in-phase/quadrature (I/Q) samples from the analog baseband and perform detection, demodulation, and decoding with reporting back to the MCU. For transmit-side functionality, the MCU presents transmittable data and auxiliary information to the DSP, which encodes the data and provides to the analog baseband (e.g., converted to analog signals by the DAC). The application processor may be embodied as a System on a Chip (SOC), and supports a plurality of multimedia related features including web browsing to access one or more computing devices of the computing system 22 that are coupled to the Internet, email, multimedia entertainment, games, etc.

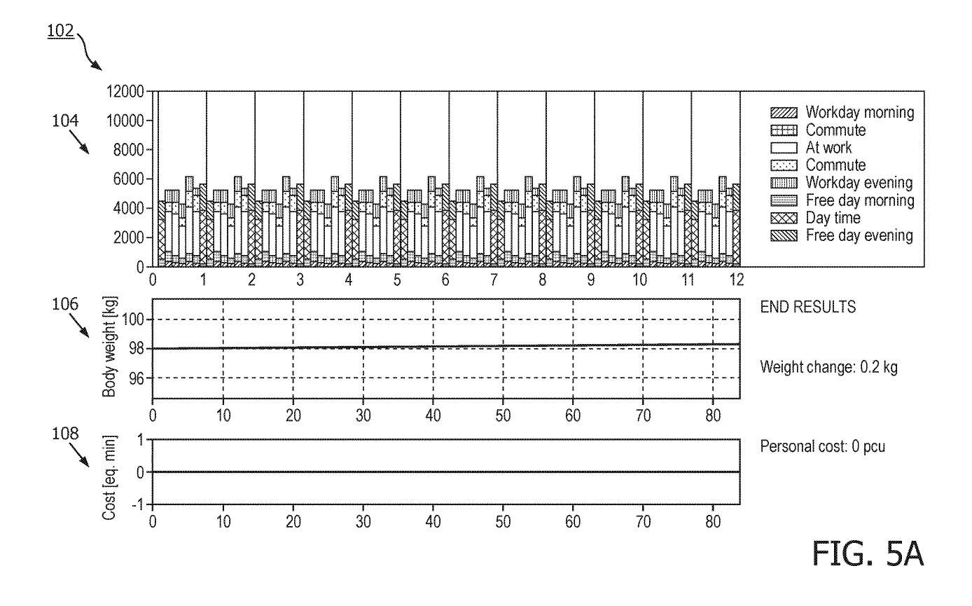

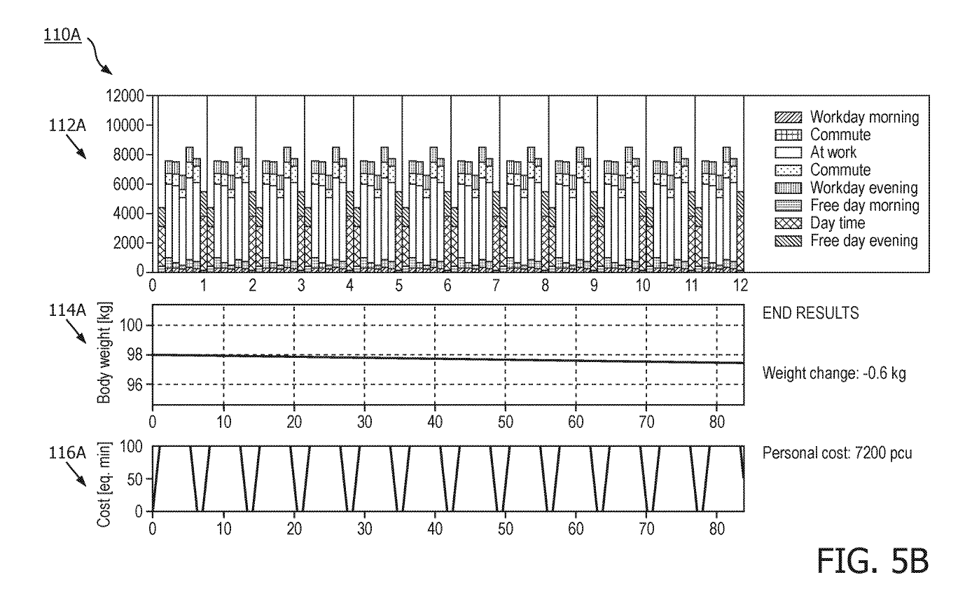

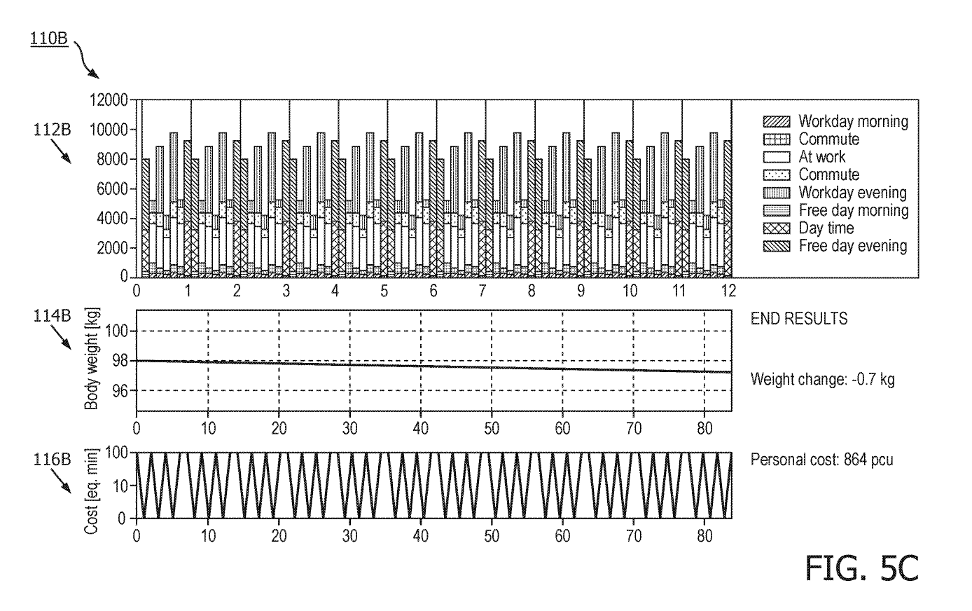

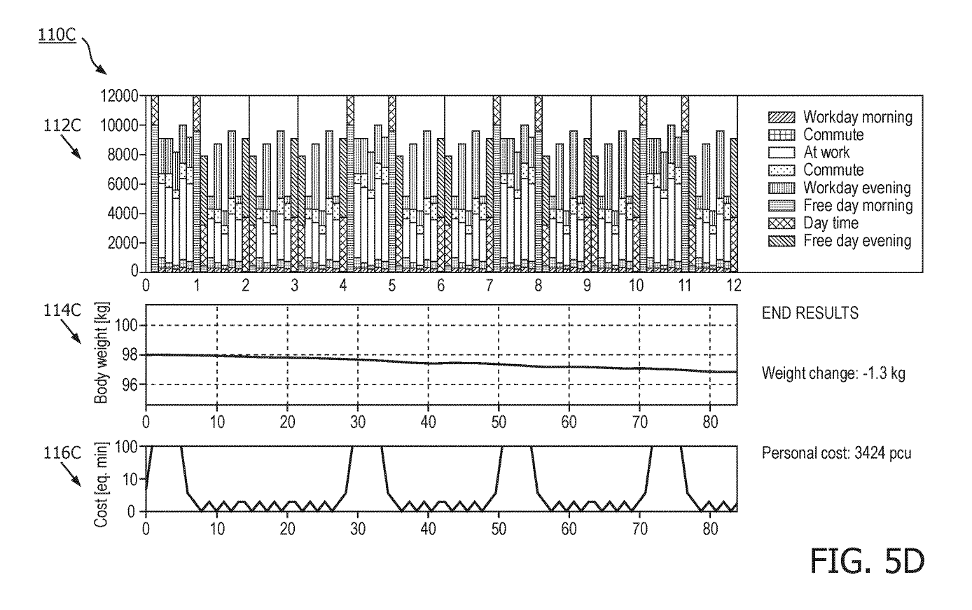

The application processor includes an operating system that enables the implementation of a plurality of user applications. For instance, the application processor may deploy interface software (e.g., middleware, such as a browser with or operable in association with one or more application program interfaces (APIs)) to enable access to a cloud computing framework or other networks to provide remote data access/storage/processing, and through cooperation with an embedded operating system, access to calendars, location services, reminders, etc. For instance, in some embodiments, the health coaching system may operate using cloud computing, where the processing and storage of user data and the determination of health plans and generation of scenarios using simulated data may be achieved by one or more devices of the computing system 22. The application processor generally comprises a processor core (Advanced RISC Machine or ARM), multimedia modules (for decoding/encoding pictures, video, and/or audio), a graphics processing unit (GPU), wireless interfaces, and device interfaces. The wireless interfaces may include a Bluetooth or Zigbee module(s) that enables wireless communication with the wearable device 12 or other local devices, a Wi-Fi module for interfacing with a local 802.11 network, and a GSM module for access to the cellular network 18 and the wide area network 20. The device interfaces coupled to the application processor may include a respective interface for such devices as a display screen. The display screen may be embodied in one of several available technologies, including LCD or Liquid Crystal Display (or variants thereof, such as Thin Film Transistor (TFT) LCD, In Plane Switching (IPS) LCD)), light-emitting diode (LED)-based technology, such as organic LED (OLED), Active-Matrix OLED (AMOLED), or retina or haptic-based technology. For instance, the display screen may be used to present web pages and/or other documents received from the computing system 22 and/or in some embodiments (e.g., for local processing) graphic user interfaces (GUIs) rendered locally, either of which may present feedback in the form of a visual representation of the health plan and associated data, as described further below in association with FIGS. 5A-D. Other interfaces include a keypad, USB (Universal Serial Bus), SD/MMC card, camera, GPRS, Wi-Fi, GPS, and/or FM radios, memory, among other devices. It should be appreciated by one having ordinary skill in the art, in the context of the present disclosure, that variations to the above may be deployed in some embodiments to achieve similar functionality.

The computer 16 may be embodied as a laptop, personal computer, workstation, personal digital assistant, tablet, among other computing devices with communication capability. The computer 16 may be in wireless or wired (e.g., temporarily, such as via USB connection, or persistently, such as an Internet connection or local area network connection) communication with other devices. The computer 16 may include similar hardware and software/firmware to that described above for the phone 14 to enable access to wireless and/or cellular networks (e.g., through communication cards comprising radio and/or cellular modem functionality) and/or other devices (e.g., Bluetooth transceivers, NFC transceivers, etc.), such as wireless or (temporary) wired connection to the wearable device 12. In some implementations, the computer 16 may be coupled to the Internet 20 through the plain old telephone service (POTS), using technologies such as digital subscriber line (DSL), asymmetric DSL (ADSL), and/or according to broadband technology that uses a coaxial, twisted pair, and/or fiber optic medium. Discussion of such communication functionality is omitted here for brevity. Generally, in terms of hardware architecture, the computer 16 includes a processor, memory, and one or more input and/or output (I/O) devices (or peripherals) that are communicatively coupled via a local interface. The local interface can be, for example but not limited to, one or more buses or other wired or wireless connections. The local interface may have additional elements, which are omitted for brevity, such as controllers, buffers (caches), drivers, repeaters, and receivers, to enable communications. Further, the local interface may include address, control, and/or data connections to enable appropriate communications among the aforementioned components.

The processor is a hardware device for executing software, particularly that stored in memory. The processor can be any custom made or commercially available processor, a central processing unit (CPU), an auxiliary processor among several processors associated with the computer 16, a semiconductor based microprocessor (in the form of a microchip or chip set), a macroprocessor, or generally any device for executing software instructions.

The memory can include any one or combination of volatile memory elements (e.g., random access memory (RAM, such as DRAM, SRAM, SDRAM, etc.) and nonvolatile memory elements (e.g., ROM, hard drive, Flash, EPROM, EEPROM, CDROM, etc.). Moreover, the memory may incorporate electronic, magnetic, optical, semi-conductive, and/or other types of storage media. Note that the memory can have a distributed architecture, where various components are situated remote from one another, but can be accessed by the processor.

The software in memory may include one or more separate programs, such as interface software (e.g., middleware, such as browser software with or associated with one or more APIs) to communicate with other network devices, such as one or more devices of the computing system 22, the separate programs each comprising an ordered listing of executable instructions for implementing logical functions. The software in the memory also includes application software and a suitable operating system (O/S). The operating system may be embodied as a Windows operating system available from Microsoft Corporation, a Macintosh operating system available from Apple Computer, a UNIX operating system, among others. The operating system essentially controls the execution of other computer programs, and provides scheduling, input-output control, file and data management, memory management, and communication control and related services.

The I/O devices may include input devices, for example but not limited to, a keyboard, mouse, scanner, microphone, etc. Furthermore, the I/O devices may also include output devices, for example but not limited to, a printer, display, etc. For instance, the I/O devices embodied as a display screen may be used to present web pages and/or other documents received from the computing system 22 and/or in some embodiments (e.g., for local processing) graphic user interfaces (GUIs) rendered locally, either of which may present feedback in the form of a visual representation of the health plan and associated data, as described further below in association with FIGS. 5A-D. The display screen may be configured according to any one of a variety of technologies, including cathode ray tube (CRT), liquid crystal display (LCD), plasma, haptic, among others well-known to those having ordinary skill in the art.

If the computer is a PC, workstation, or the like, the software in the memory may further include a basic input output system (BIOS). The BIOS is a set of essential software routines that initialize and test hardware at startup, start the O/S, and support the transfer of data among the hardware devices. The BIOS is stored in ROM so that the BIOS can be executed when the computer 16 is activated.

When the computer 16 is in operation, the processor is configured to execute the software stored within the memory, to communicate data to and from the memory, and to generally control operations of the computer 16 pursuant to the software. Software can be stored on any non-transitory computer readable medium for use by or in connection with any computer related system or method. In the context of this document, a computer readable medium comprises an electronic, magnetic, optical, electromagnetic, infrared, or semiconductor system, apparatus, device or means that can contain or store a computer program for use by or in connection with a computer related system or method. The software can be embodied in any non-transitory computer-readable medium for use by or in connection with an instruction execution system, apparatus, or device, such as a computer-based system, processor-containing system, or other system that can fetch the instructions from the instruction execution system, apparatus, or device and execute the instructions.

The cellular network 18 may include the necessary infrastructure to enable cellular communications by the phone 14 and optionally the computer 16. There are a number of different digital cellular technologies suitable for use in the cellular network 18, including: GSM, GPRS, CDMAOne, CDMA2000, Evolution-Data Optimized (EV-DO), EDGE, Universal Mobile Telecommunications System (UMTS), Digital Enhanced Cordless Telecommunications (DECT), Digital AMPS (IS-136/TDMA), and Integrated Digital Enhanced Network (iDEN), among others.

The wide area network 20 may comprise one or a plurality of networks that in whole or in part comprise the Internet. The electronics devices 14, 16 access the devices of the computing system 22 via the Internet 20, which may be further enabled through access to one or more networks including PSTN (Public Switched Telephone Networks), POTS, Integrated Services Digital Network (ISDN), Ethernet, Fiber, DSL/ADSL, among others.

The computing system 22 comprises a plurality of devices coupled to the wide area network 20, including one or more computing devices such as application servers, a computer network, and data storage. As described previously, the computing system 22 may serve as a cloud computing environment (or other server network) for the electronics devices 14, 16, performing processing and data storage on behalf of (or in some embodiments, in addition to) the electronics devices 14, 16. In some embodiments, one or more of the functionality of the computing system 22 may be performed at the respective electronics devices 14, 16.

An embodiment of a health coaching system may comprise one or more devices (or equivalently, one or more apparatuses) of the computing system 22, or in some embodiments, a combination of one or more of the electronics devices 14, 16 and one or more devices of the computing system 22, or in some embodiments, a combination of the wearable device 12, one or more of the electronics devices 14, 16, and one or more devices of the computing system 22. In some embodiments, the health coaching system functionality may be carried out locally, such as via one or more of the electronics devices 14, 16, or a combination of the one or more of the electronics devices 14, 16 and the wearable device 12.

Having generally described an example environment 10 in which an embodiment of a health coaching system may be implemented, attention is directed to FIG. 2. FIG. 2 illustrates example circuitry for the example wearable device 12, and in particular, underlying circuitry and software (e.g., architecture) of the wearable device 12. It should be appreciated by one having ordinary skill in the art in the context of the present disclosure that the architecture of the wearable device 12 depicted in FIG. 2 is but one example, and that in some embodiments, additional, fewer, and/or different components may be used to achieve similar and/or additional functionality. In one embodiment, the wearable device 12 comprises a plurality of sensors 24 (e.g., 24A-24N), one or more signal conditioning circuits 26 (e.g., SIG COND CKT 26A-SIG COND CKT 26N) coupled respectively to the sensors 24, and a processing circuit 28 (PROCES CKT) that receives the conditioned signals from the signal conditioning circuits 26. In one embodiment, the processing circuit 28 comprises an analog-to-digital converter (ADC), a digital-to-analog converter (DAC), a microcontroller (e.g., MCU), a digital signal processor (DSP), and memory (MEM). In some embodiments, the processing circuit 28 may comprise fewer or additional components than those depicted in FIG. 2. For instance, in one embodiment, the processing circuit 28 may consist of the microcontroller. The memory comprises an operating system (OS) and application software. The application software comprises a plurality of algorithms (e.g., application modules of executable code) to process the signals (and associated data) measured by the sensors and record and/or derive physiological parameters, such as heart rate, blood pressure, respiration, perspiration, etc. The application software also comprises communications software, such as that used to enable the wearable device 12 to operate according to one or more of a plurality of different communication technologies (e.g., NFC, Bluetooth, Wi-Fi, Zigbee, etc.). In some embodiments, the communications software may be in separate or other memory.

The memory further comprises one or more data structures. In one embodiment, the processing circuit 28 is coupled to a communications circuit 30. The communications circuit 30 serves to enable wireless communications between the wearable device 12 and other electronics devices, such as the phone 14, the laptop 16, and/or other devices. The communications circuit 30 is depicted as a Bluetooth circuit, though not limited to this transceiver configuration. For instance, in some embodiments, the communications circuit 30 may be embodied as any one or a combination of an NFC circuit, Wi-Fi circuit, transceiver circuitry based on Zigbee, among others such as optical or ultrasonic based technologies. The processing circuit 28 is further coupled to input/output (I/O) devices or peripherals, such as an input interface 32 (INPUT) and output interface 34 (OUT). Note that in some embodiments, functionality for one or more of the aforementioned circuits and/or software may be combined into fewer components/modules, or in some embodiments, further distributed among additional components/modules. For instance, the processing circuit 28 may be packaged as an integrated circuit that includes the microcontroller, the DSP, and memory, whereas the ADC and DAC may be packaged as a separate integrated circuit coupled to the processing circuit 28. In some embodiments, one or more of the functionality for the above-listed components may be combined, such as functionality of the DSP performed by the microcontroller.

The sensors 24 are selected to perform detection and measurement of a plurality of physiological and behavioral parameters, including heart rate, heart rate variability, heart rate recovery, blood flow rate, activity level, muscle activity (e.g., movement of limbs, repetitive movement, core movement, body orientation/position, power, speed, acceleration, etc.), muscle tension, blood volume, blood pressure, blood oxygen saturation, respiratory rate, perspiration, skin temperature, body weight, and body composition (e.g., body mass index or BMI). The sensors 24 may be embodied as inertial sensors (e.g., gyroscopes, single or multi-axis accelerometers, such as those using piezoelectric, piezoresistive or capacitive technology in a microelectromechanical system (MEMS) infrastructure), flex and/or force sensors (e.g., using variable resistance), electromyographic sensors, electrocardiographic sensors (e.g., EKG, ECG) magnetic sensors, photoplethysmographic (PPG) sensors, bio-impedance sensors, infrared proximity sensors, acoustic/ultrasonic/audio sensors, a strain gauge, galvanic skin/sweat sensors, pH sensors, temperature sensors, pressure sensors, and photocells. In some embodiments, other types of sensors 24 may be used to facilitate health and/or fitness related computations, including a global navigation satellite systems (GNSS) sensor (e.g., global positioning system (GPS) receiver) to facilitate determinations of distance, speed, acceleration, location, altitude, etc. (e.g., location data and movement), barometric pressure, humidity, outdoor temperature, etc. In some embodiments, GNSS functionality may be achieved via the communications circuit 30 or other circuits coupled to the processing circuit 28.

The signal conditioning circuits 26 include amplifiers and filters, among other signal conditioning components, to condition the sensed signals including data corresponding to the sensed physiological parameters before further processing is implemented at the processing circuit 28. Though depicted in FIG. 2 as respectively associated with each sensor 24, in some embodiments, fewer signal conditioning circuits 26 may be used (e.g., shared for more than one sensor 24). In some embodiments, the signal conditioning circuits 26 (or functionality thereof) may be incorporated elsewhere, such as in the circuitry of the respective sensors 24 or in the processing circuit 28 (or in components residing therein). Further, although described above as involving unidirectional signal flow (e.g., from the sensor 24 to the signal conditioning circuit 26), in some embodiments, signal flow may be bi-directional. For instance, in the case of optical measurements, the microcontroller may cause an optical signal to be emitted from a light source (e.g., light emitting diode(s) or LED(s)) in or coupled to the circuitry of the sensor 24, with the sensor 24 (e.g., photocell) receiving the reflected/refracted signals.

The communications circuit 30 is managed and controlled by the processing circuit 28. The communications circuit 30 is used to wirelessly interface with the electronics devices 14, 16 (FIG. 1). In one embodiment, the communications circuit 30 may be configured as a Bluetooth transceiver, though in some embodiments, other and/or additional technologies may be used, such as Wi-Fi, Zigbee, NFC, among others. In the embodiment depicted in FIG. 2, the communications circuit 30 comprises a transmitter circuit (TX CKT), a switch (SW), an antenna, a receiver circuit (RX CKT), a mixing circuit (MIX), and a frequency hopping controller (HOP CTL). The transmitter circuit and the receiver circuit comprise components suitable for providing respective transmission and reception of an RF signal, including a modulator/demodulator, filters, and amplifiers. In some embodiments, demodulation/modulation and/or filtering may be performed in part or in whole by the DSP. The switch switches between receiving and transmitting modes. The mixing circuit may be embodied as a frequency synthesizer and frequency mixers, as controlled by the processing circuit 28. The frequency hopping controller controls the hopping frequency of a transmitted signal based on feedback from a modulator of the transmitter circuit. In some embodiments, functionality for the frequency hopping controller may be implemented by the microcontroller or DSP. Control for the communications circuit 30 may be implemented by the microcontroller, the DSP, or a combination of both. In some embodiments, the communications circuit 30 may have its own dedicated controller that is supervised and/or managed by the microcontroller.

In operation, a signal (e.g., at 2.4 GHz) may be received at the antenna and directed by the switch to the receiver circuit. The receiver circuit, in cooperation with the mixing circuit, converts the received signal into an intermediate frequency (IF) signal under frequency hopping control attributed by the frequency hopping controller and then to baseband for further processing by the ADC. On the transmitting side, the baseband signal (e.g., from the DAC of the processing circuit 28) is converted to an IF signal and then RF by the transmitter circuit operating in cooperation with the mixing circuit, with the RF signal passed through the switch and emitted from the antenna under frequency hopping control provided by the frequency hopping controller. The modulator and demodulator of the transmitter and receiver circuits may be frequency shift keying (FSK) type modulation/demodulation, though not limited to this type of modulation/demodulation, which enables the conversion between IF and baseband. In some embodiments, demodulation/modulation and/or filtering may be performed in part or in whole by the DSP. The memory stores firmware that is executed by the microcontroller to control the Bluetooth transmission/reception.

Though the communications circuit 30 is depicted as an IF-type transceiver, in some embodiments, a direct conversion architecture may be implemented. As noted above, the communications circuit 30 may be embodied according to other and/or additional transceiver technologies, such as NFC, Wi-Fi, or Zigbee.

The processing circuit 28 is depicted in FIG. 2 as including the ADC and DAC. For sensing functionality, the ADC converts the conditioned signal from the signal conditioning circuit 26 and digitizes the signal for further processing by the microcontroller and/or DSP. The ADC may also be used to convert analogs inputs that are received via the input interface 32 to a digital format for further processing by the microcontroller. The ADC may also be used in baseband processing of signals received via the communications circuit 30. The DAC converts digital information to analog information. Its role for sensing functionality may be to control the emission of signals, such as optical signals or acoustic signal, from the sensors 24. The DAC may further be used to cause the output of analog signals from the output interface 34. Also, the DAC may be used to convert the digital information and/or instructions from the microcontroller and/or DSP to analog signal that are fed to the transmitter circuit. In some embodiments, additional conversion circuits may be used.

The microcontroller and the DSP provide the processing functionality for the wearable device 12. In some embodiments, functionality of both processors may be combined into a single processor, or further distributed among additional processors. The DSP provides for specialized digital signal processing, and enables an offloading of processing load from the microcontroller. The DSP may be embodied in specialized integrated circuit(s) or as field programmable gate arrays (FPGAs). In one embodiment, the DSP comprises a pipelined architecture, with comprises a central processing unit (CPU), plural circular buffers and separate program and data memories according to a Harvard architecture. The DSP further comprises dual busses, enabling concurrent instruction and data fetches. The DSP may also comprise an instruction cache and I/O controller, such as those found in Analog Devices SHARC® DSPs, though other manufacturers of DSPs may be used (e.g., Freescale multi-core MSC81xx family, Texas Instruments C6000 series, etc.). The DSP is generally utilized for math manipulations using registers and math components that may include a multiplier, arithmetic logic unit (ALU, which performs addition, subtraction, absolute value, logical operations, conversion between fixed and floating point units, etc.), and a barrel shifter. The ability of the DSP to implement fast multiply-accumulates (MACs) enables efficient execution of Fast Fourier Transforms (FFTs) and Finite Impulse Response (FIR) filtering. The DSP generally serves an encoding and decoding function in the wearable device 12. For instance, encoding functionality may involve encoding commands or data corresponding to transfer of information to the electronics devices 14, 16. Also, decoding functionality may involve decoding the information received from the sensors 24 (e.g., after processing by the ADC).

The microcontroller comprises a hardware device for executing software/firmware, particularly that stored in memory. The microcontroller can be any custom made or commercially available processor, a central processing unit (CPU), a semiconductor based microprocessor (in the form of a microchip or chip set), a macroprocessor, or generally any device for executing software instructions. Examples of suitable commercially available microprocessors include Intel's® Itanium® and Atom® microprocessors, to name a few non-limiting examples. The microcontroller provides for management and control of the wearable device 12, including determining physiological parameters based on the sensors 24, and for enabling communication with the electronics devices 14, 16.

The memory can include any one or combination of volatile memory elements (e.g., random access memory (RAM, such as DRAM, SRAM, SDRAM, etc.)) and nonvolatile memory elements (e.g., ROM, Flash, solid state, EPROM, EEPROM, etc.). Moreover, the memory may incorporate electronic, magnetic, and/or other types of storage media.

The software in memory may include one or more separate programs, each of which comprises an ordered listing of executable instructions for implementing logical functions. In the example of FIG. 2, the software in the memory includes a suitable operating system and application software that includes a plurality of algorithms for determining physiological and/or behavioral measures and/or other information (e.g., such as location) based on the output from the sensors 24. The raw data from the sensors 24 may be used by the algorithms to determine various physiological and/or behavioral measures (e.g., heart rate, biomechanics, such as swinging of the arms), and may also be used to derive other parameters, such as energy expenditure, heart rate recovery, aerobic capacity (e.g., VO2 max, etc.), among other derived measures of physical performance. In some embodiments, these derived parameters may be computed externally (e.g., at the electronics devices 14, 16 or one or more devices of the computing system 22) in lieu of, or in addition to, the computations performed local to the wearable device 12. The application software may also include communications software to enable communications with other electronics devices. The operating system essentially controls the execution of other computer programs, such as the application software and communications software, and provides scheduling, input-output control, file and data management, memory management, and communication control and related services. The memory may also include a data structure, which includes user data, such as weight, height, age, gender, body mass index (BMI) that is used by the microcontroller executing the executable code of the algorithm to accurately interpret the measured physiological and/or behavioral data. In some embodiments, the data structure of user data may be stored elsewhere, such as at the electronics devices 14, 16 and/or at one or more devices of the computing system 22 in lieu of, or in addition to being stored at the wearable device 12.

The software in memory comprises a source program, executable program (object code), script, or any other entity comprising a set of instructions to be performed. When a source program, then the program may be translated via a compiler, assembler, interpreter, or the like, so as to operate properly in connection with the operating system. Furthermore, the software can be written as (a) an object oriented programming language, which has classes of data and methods, or (b) a procedure programming language, which has routines, subroutines, and/or functions, for example but not limited to, C, C++, Python, Java, among others. The software may be embodied in a computer program product, which may be a non-transitory computer readable medium or other medium.

The input interface 32 comprises an interface for entry of user input, such as a button or microphone or sensor (e.g., to detect user input). The input interface 32 may serve as a communications port for downloaded information to the wearable device 12 (such as via a wired connection). The output interfaces 34 comprises an interface for the presentation or transfer of data, such as a display or communications interface for the transfer (e.g., wired) of information stored in the memory, or to enable one or more feedback devices, such as lighting devices (e.g., LEDs), audio devices (e.g., tone generator and speaker), and/or tactile feedback devices (e.g., vibratory motor). In some embodiments, at least some of the functionality of the input and output interfaces 32 and 34 may be combined.

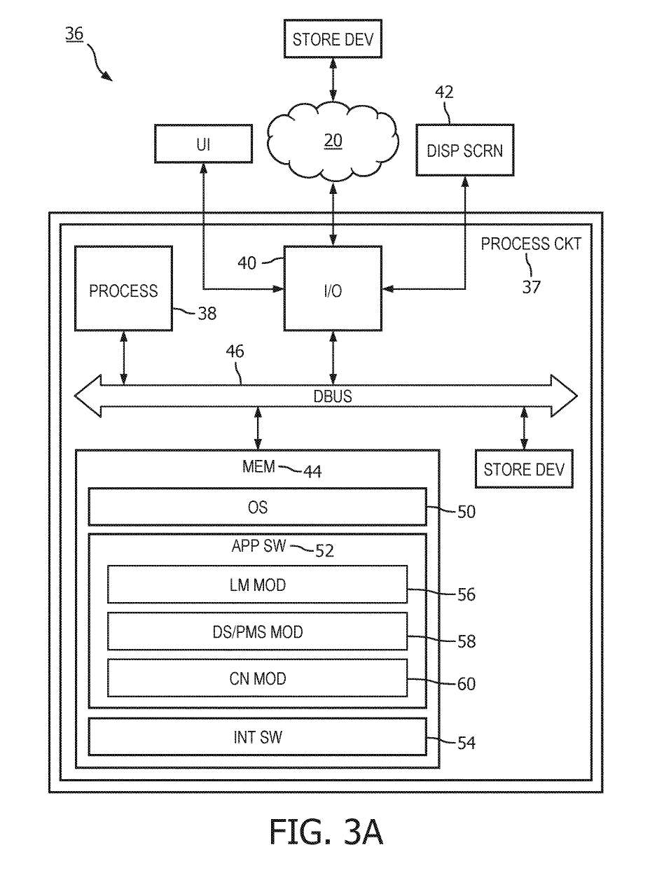

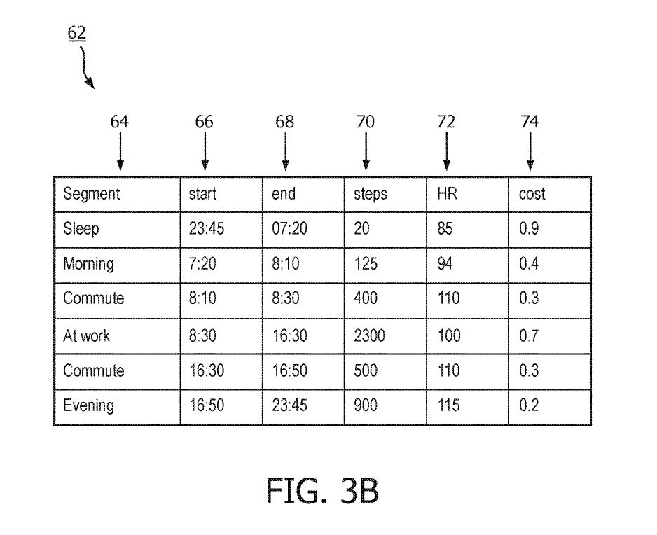

Having described the underlying hardware and software of the wearable device 12, attention is now directed to FIG. 3A, which illustrates circuitry for an example computing device 36 of the computing system 22, in accordance with an embodiment of the invention. The computing device 36 may be embodied as an application server, computer, among other computing devices, and is also generally referred to herein as an apparatus. One having ordinary skill in the art should appreciate in the context of the present disclosure that the example computing device 36 is merely illustrative of one embodiment, and that some embodiments of computing devices may comprise fewer or additional components, and/or some of the functionality associated with the various components depicted in FIG. 3A may be combined, or further distributed among additional modules or computing devices, in some embodiments. The computing device 36 is depicted in this example as a computer system, such as one providing a function of an application server. It should be appreciated that certain well-known components of computer systems are omitted here to avoid obfuscating relevant features of the computing device 36. In one embodiment, the computing device 36 comprises a processing circuit 37 (PROCES CKT) that comprises one or more processors, such as processor 38 (PROCES), input/output (I/O) interface(s) 40 (I/O), which in one embodiment is optionally coupled to a display screen 42 (DISP SCRN) and other user interfaces (e.g., keyboard, mouse, microphone, etc.), and memory 44 (MEM), all coupled to one or more data busses, such as data bus 46 (DBUS). In some embodiments, the display screen 42 (and/or user interface (UI)) may be coupled directly to the data bus 46. The memory 44 may include any one or a combination of volatile memory elements (e.g., random-access memory RAM, such as DRAM, and SRAM, etc.) and nonvolatile memory elements (e.g., ROM, Flash, solid state, EPROM, EEPROM, hard drive, tape, CDROM, etc.). The memory 44 may store a native operating system, one or more native applications, emulation systems, or emulated applications for any of a variety of operating systems and/or emulated hardware platforms, emulated operating systems, etc. In some embodiments, a separate storage device (STOR DEV) may be coupled to the data bus 46 or as a network-connected device (or devices) via the I/O interfaces 40 and the Internet 20. The storage device may be embodied as persistent memory (e.g., optical, magnetic, and/or semiconductor memory and associated drives) to store user data (e.g., based on questionnaires, recorded data communicated from the wearable device 12, and/or via data entered in web pages accessed at the electronics devices 14, 16).

In the embodiment depicted in FIG. 3A, the memory 44 comprises an operating system 50 (OS), application software 52 (APP SW), and interface software 54 (INT SW), the latter for enabling communications among network-connected devices and providing web and/or cloud services, among other software such as one or more APIs. The application software 52 comprises a lifestyle model (LM) module 56 (LM MOD), a data simulation (DS)/physiological model simulation (PMS) module 58 (DS/PMS MOD), and a change negotiation (CN) module 60 (CN MOD). The LM module 56 collects and arranges data obtained from or about the subject, such as recurring routines and measurement data of the subject in semantic contexts (e.g., types of behavior). In one embodiment, the LM module 56 arranges measurement data in semantic contexts or, as used equivalently herein, types of behavior. For example, the LM module 56 represents a work day as an array 62 as shown in FIG. 3B. The array 62 may be stored in memory 44, in one or more storage devices coupled directly to the computing device 36 or in network-connected storage device or devices. In this example, the array 62 is arranged in segments 64 of the day categorized as types of behavior, including sleep, morning, commute, at work, commute, and evening. For instance, the subject may engage in one type of behavior during the sleep segment that differs than the type of behavior engaged in by the subject during the commute time segment. The segmentation of a day to sleep, morning, commute, work period, and evening at home is also an example which is in practice very applicable for a person with regular working hours. The transfers or transitions between different segments can be determined by the LM module 56, for example, based on location data tracked by the LM module 56 (or other applications in some embodiments). Each segment 64 has (e.g., is defined by) a corresponding start 66 and an end 68 (collectively, a duration). The array 62 further comprises for each segment a physical activity 70 engaged in by the subject during the respective time segment. In this example, the physical activity is steps, but in some embodiments, the physical activity may be one or more other types of physical activity (e.g., health-related or other types of activity, such as eating, sleeping, etc.) and/or additional types of physical activity. The array 62 further comprises a physiological parameter 72 recorded by the wearable device 12 (FIG. 1) and communicated to the computing device 36. In this example, heart rate is the physiological parameter, though others and/or additional parameters may be recorded, such as weight, body fat percentage, etc. Note that the values for the physiological parameter 72 correspond to average times. In some embodiments, the values may be represented by distribution parameters of the measurements.

In one embodiment, the LM module 56 provides several different profiles computed for each subject. For example, the LM module 56 may provide profiles for a work day, for a weekend or a free day, and/or a separate profile for each weekday. The LM module 56 associates each time segment 64 with a cost parameter 74 (or simply, cost), which may be pre-defined or estimated from the responses of the subject (e.g., estimate the cost from the behavior of the user), or measured using a questionnaire or an interview of the subject. The cost parameter 74 corresponds to a relative convenience for the subject to perform the physical activity during the respective time segment. In one embodiment, the higher the cost parameter 74, the more difficult it is to fit the physical activity into that time segment. For example, at a cost value of 0.9, it is more difficult to add physical activity during the corresponding sleep time segment than it is to add physical activity during the evening time segment, which has a cost parameter of 0.2. It should be appreciated by one having ordinary skill in the art in the context of the present disclosure that the array 62 is but one example data structure, and that some embodiments or implementations may store additional or different types of behavior and/or different quantities or types of physical activity and/or physiological measurements. Further, in some embodiments, the scale of higher to lower cost may be altered (e.g., expanded in range, shortened, etc.) to suit the needs of the application.

Referring again to FIG. 3A, the application software 52 further comprises the DS/PMS module 58. The DS/PMS module 58 generates simulated data based on the LM module output and modifications to parameters of the LM module data and derives forecasts and indirect measurements from measurement data. The DS/PMS module 58 also has access to information about the weight, height, age, gender and possibly other measures related to the subject. Such information may be received from the wearable device 12 (via the electronics devices 14, 16) and/or received via subject data entry on a website, questionnaire, etc. This information makes it possible for the DS/PMS module 58 to estimate, for example, the physical activity energy expenditure corresponding to a base unit of physical activity, such as one step eₛₜₑₚ in walking. In some embodiments, instead of the eₛₜₑₚ parameter, an activity type may be inferred and a corrected metabolic equivalent (MET) value above resting MET may be used. In some embodiments, an intensity measure may be used. The physical activity energy expenditure of a subject or user u (user and subject used interchangeably herein) in walking, computed over S segments s, s=0 . . . S−1 in one day d, can then be estimated as follows:

Eᵤ(d)=Σₛ^{S-1}TₛMₛeₛₜₑₚ (1)

where Tₛ and Mₛ represent the duration and the step count in the segment s, respectively. This example describes only the physical activity energy expenditure related to the physical activity of walking, whereas in some implementations, other and/or additional activity types may be incorporated (e.g., as a summation in (1)) to give a more comprehensive picture of the daily physical activity energy expenditure E. The physical activity energy expenditure computations are part of the simulation process. In some embodiments, as suggested above, the simulations include estimates of the physical activity energy expenditure for a given activity type and the intensity of the physical activity. In some embodiments, the simulations include physical activity energy expenditure values computed based on corrected MET values tabulated for typical activities above resting values.

The DS/PMS module 58 further provides for any one of a plurality of types of computational models dealing with interactions of physiological parameters. Such computational models may be used to provide reliable predictions of body weight or body fat percentage (or other physiological parameters) as a function of time when the model is fed with information such as a physiological profile, daily activity, and nutrition data. Two example computation models may include those described by Hall et al. (Hall K D, Sacks G, Chandramohan D, et al. Quantification of the effect of energy imbalance on bodyweight. Lancet 2011; 378: 826-37) and Thomas et al. (Thomas D M, Martin C K, Heymsfield S, et al. A Simple Model Predicting Individual Weight Change in Humans. J Biol Dyn. 2011; 5(6): 579-99), though not limited to these models. For instance, the personal data and estimate of the food intake may be based on questionnaire (e.g., web-based or otherwise), estimated from the data, and/or recorded by various sensing mechanisms in the wearable device 12. An output of the DS/PMS module 58 comprises a sequence or time series of expected measurements. For example, using a Hall computational model, the output may be a time-series of weight estimates W(d) (or body fat percentages BF % (d)) as a function of day count d=0, . . . D−1, i.e.,

W(d)=H(Eᵤ(d),Nᵤ(d),Pᵤ),

where H ( ) is the Hall computational model (although in some implementations, other computation models, such as by Thomas et al. or others may be used), Nu comprises the macronutrient intake, Pu comprises user profile information (e.g., gender, age, height, weight, etc.), and Eu is the physical activity energy expenditure as described previously. Collectively, the physical activity energy expenditure, profile information, and nutrient intake information comprise a total energy expenditure which includes thermic, adaptive, and resting levels depending on such user information as age, gender, body size/composition, etc., versus a physical activity energy expenditure, or Eu). Note that the Hall model is a discretized system of differential equations, which are typically evaluated over time in a software tool that is often referred to as a differential equation solver or modeler. The system state variables computed for one day comprise partial inputs to the computation of the values of the next day.

The simulation performed by the DS/PMS module 58 is based on computation of expected measures applied to the future and using the physiological model aspect of the DS/PMS module 58 to forecast the changes in physiological parameters. In one embodiment, such simulations may use an alternating pattern of days that corresponds to the regular behavioral pattern observed in the subject (e.g., five (5) work days and two (2) free days on the weekend). The DS/PMS module 58 also simulates several scenarios using modifications to the physical activity. For instance, scenarios are simulated where the physical activity (e.g., step count values) are modified, which may lead to a modification in the start and end times of the time segments. The expected physical activity energy expenditure in each scenario j is calculated by the DS/PMS module 58 using equation (1) noted above, and the DS/PMS module 58 computes the expected weight or body fat change trajectory W(t), BF % (d) from each scenario. In addition, the DS/PMS module 58 computes the change in the cost of the simulated behavior change. In one embodiment a baseline cost X_{b}(d) of a day is computed as the following sum:

$${X}_{b} ( d ) = {\sum }_{s}^{S - 1} {T}_{s} {steps}_{s} {coststep}_{s} \pm {cal}_{s} {costcal}_{s}$$

Similarly the DS/PMS module 58 computes the cost of a simulated scenario j with the same cost coefficients but with new step counts s̅t̅e̅p̅s̅ₛ and calorie intake c̅a̅l̅ₛ in at least one or all of the segments:

$${X}_{j} ( d ) = {\sum }_{s}^{S - 1} {T}_{s} {{steps}^{\overline{\_}}}_{s} {coststep}_{s} \pm {{cal}^{\overline{\_}}}_{s} {costcal}_{s}$$

This computation process is repeated for the entire simulation duration d=1, . . . D where D in one embodiment is typically more than ten (10) days but less than three hundred sixty-five (356) days. The weights coststepₛ and costcalₛ used by the DS/PMS module 58 in the above computations are personalized (e.g., coststep and costcal parameters are based on the user), for example, based on user questionnaire or other information. Note that the examples above use a linear weighted sum, though some embodiments may use other ways to combine the final cost. For example, the cost computation may involve a non-linear modification of the step counts to give more emphasis for large step counts and eliminate the effect of very small relative or absolute step counts on the final cost. The values may also be mapped to some other measurement attribute, for example, the step counts may be converted to minutes or distance of walking, or some artificial derived measure. The individual costs may also depend on the step count. For example, at work, a small increase in step count (e.g., four hundred (400) steps) may have a small cost per step, but addition of, say, four thousand (4,000) steps has a relatively much higher cost because the user has to plan it into the workday and reserve time for it. Similarly, a reduction of 20% in caloric intake may be feasible to sustain over a prolonged period, whereas a reduction by 60% may be very hard to sustain and the cost function may take this into account.

Finally, the DS/PMS module 58 scores the j simulations by the forecasted end weight Wⱼ(D) or end body fat percentage BF % (d) and the cost difference as follows:

$${dX}_{j} = {\sum }_{d}^{D} {( {X}_{b} ( d ) - {X}_{j} ( d ) )}^{2}$$

The series of simulations thus produce a sequence of j pairs of measures (Wⱼ(D),dXⱼ). In one embodiment, the DS/PMS module 58 determines a winning simulation j according to the following equation:

$${j}_{w} = arg {max}_{j} ( \frac{{G}_{n} ( {W}_{j} ( D ) )}{{G}_{d} ( {dX}_{j} )} ) ,$$

where Gₙ( ) and G_{d}( ), in the preferred embodiment, are monotonic continuous functions, such as a linear function, an exponential function, or a sigmoidal function. In several embodiments the parameters of Gₙ( ) and G_{d}( ), can be adjusted by the user, or selected based on users preferences, e.g., on a higher efficiency of the intervention or a higher cost of the required actions.

The CN module 60 presents feedback to a user in the form of user alternative lifestyle modifications and their effects, and closes (e.g., through user acceptance) an informed agreement with a user on actions to be picked up and tracked. The CN module 60 may communicate the result to the user via an automatic system (e.g., presentation of web-pages or other documents at the electronics devices 14, 16 (FIG. 1) or other mechanisms for presenting graphical user interfaces) or via a human coach (e.g., whom receives the result via an electronics device). In both cases, one goal is to arrive at an agreement on adoption of a new health habit that relates to the selected behavior change. In some embodiments, the user is given one or more optional care plans to choose from and quantitative estimates of the associated beneficial health effects and personal costs on the corresponding optional lifestyle behaviors. Therefore, the health change opportunities, their costs on the time of the user, and the benefits towards the desired health parameters are accurately communicated to the user.

Note that in some embodiments, functionality of two or more of the modules 56-60 may be combined into a single module, or distributed among different modules in the same or different location.

One benefit of certain embodiments of the health coaching system is that the j simulations are performed in a semantically meaningful context. For example, one simulation may demonstrate that if the user takes, on the way to work each day, five hundred (500) steps more, such recommended actions can lead to a weight change (or other parameter change) that is accurately predicted (e.g., if the other aspects of the lifestyle remain the same). In other words, certain embodiments of the health coaching system presents the user a limited number of concrete opportunities based on simulations by the LM module 56 and the DS/PMS module 58. The selection of the opportunities aims at minimization of costs and maximization of the health benefits for the user. The minimization of costs is based on a model of the costs of the intervention in a particular context. The maximization is based on physiological simulation of the health effects of an intervention. As described above, an agreement is closed with the user on actions based on the simulation and thereafter monitors and supports the user in the path.

Execution of the application software 52 (and associated modules 56-60) and interface software 54 may be implemented by the processor 38 under the management and/or control of the operating system 50. The processor 38 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the computing device 36.

The I/O interfaces 40 comprise hardware and/or software to provide one or more interfaces to the Internet 20, as well as to other devices such as the display screen 42 and user interfaces. In other words, the I/O interfaces 40 may comprise any number of interfaces for the input and output of signals (e.g., analog or digital data) for conveyance of information (e.g., data) over various networks and according to various protocols and/or standards. The user interfaces may include a keyboard, mouse, microphone, immersive head set, etc., which enable input and/or output by an administrator or other user.

When certain embodiments of the computing device 36 are implemented at least in part with software (including firmware), as depicted in FIG. 3A, it should be noted that the software (e.g., such as the application software 52 and interface software 54) can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the computing device 36 are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), relays, contactors, etc.

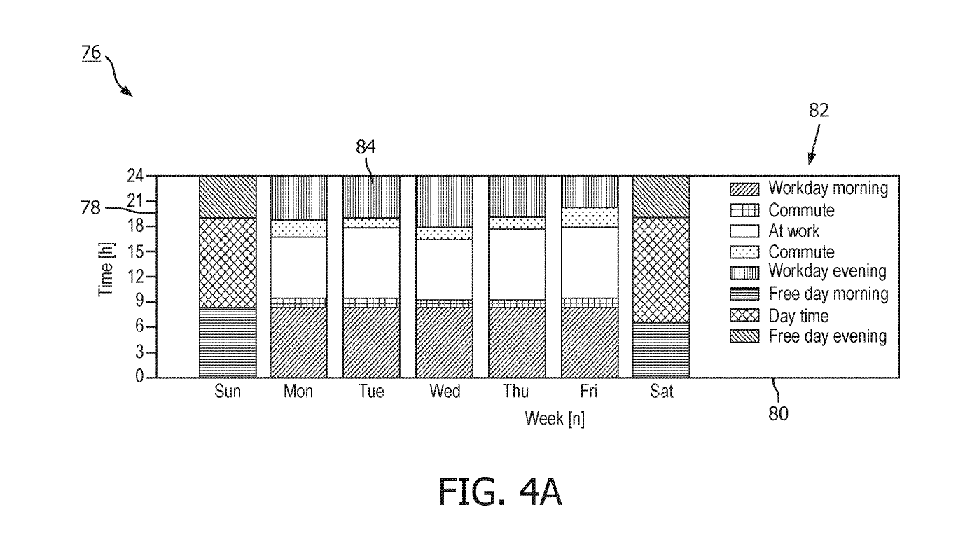

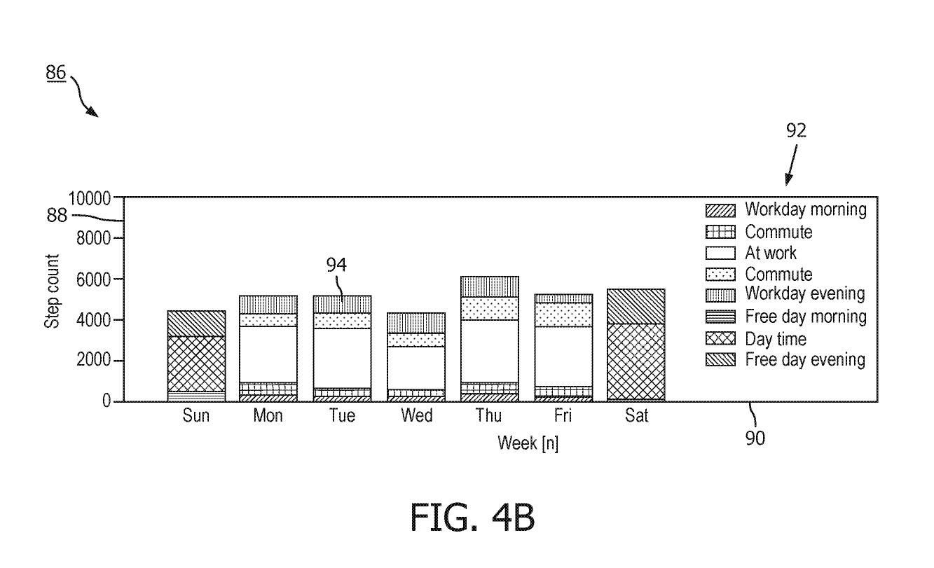

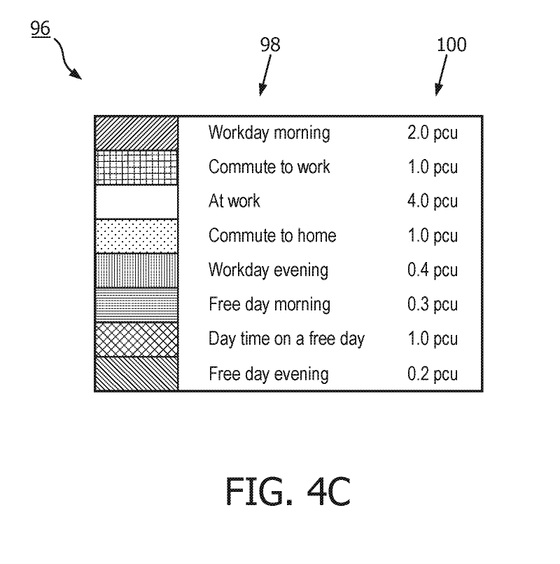

Reference is now made to FIGS. 4A-5D, which collectively illustrate, through graphical representations, a process by which an embodiment of the health coaching system generates a health plan and/or presents feedback to the user or to a third party (e.g., a coach). It should be appreciated by one having ordinary skill in the art in the context of the present disclosure that the illustrations provide one example among many that are contemplated to be within the scope of the disclosure. Beginning with FIGS. 4A-4C, shown are schematic diagrams that graphically illustrate an example process in which the computing device 36 (e.g., processing circuit 37, FIG. 3A) generates the recorded and derived data of FIG. 3B in accordance with an embodiment of the invention. The graphics (or variants thereof) presented in FIGS. 4A-4C may be presented to a user as feedback, or in some embodiments, may represent processing by the computing device 36 that is transparent to the user (e.g., are simply illustrating the underlying process of the application software 52 (FIG. 3A), or more particularly, the LM module 56, FIG. 3A). FIG. 4A shows a graphic 76, which includes a time scale 78 (y-axis, illustrating a 24 hour period or, equivalently, a day), a day scale 80 (x-axis, illustrating a predetermined time period of a week in this example), and legend 82. Recorded data representations 84 are depicted as columnar in format and graphically reveal an amount of time each day that the user's behavior falls within a certain type of behavior (semantic context). Note that other formats may be used that convey similar information in some embodiments. In other words, the graphic 76 conveys a recorded weekly profile of a user based on an activity tracker device (e.g., the wearable device 12, FIG. 2) and a location-sensing application and/or circuitry (e.g., GNSS components in the wearable device 12), and in particular, shows the time the user spends in different semantic contexts over the day and over a span of a predetermined period of time (e.g., a week). The semantic contexts or types of behavior include, as indicated in the legend 82 in this example, workday morning, commute, at work, commute, workday evening, free day morning, day time, and free day evening. Looking at the recorded data representations 84 for Sunday and Saturday, the respective columns of data (viewed from the bottom up) include free day morning, followed by a transition in time segment to day time, which is followed by a transition in time segment to free day evening. Each time segment occupies a different portion of the day. Referring to the columns of the recorded data representations 84 for Monday through Friday, and again viewing from the bottom-up, the bottom time segment corresponds to a workday morning, followed by a transition to a commute, followed by at work, followed by a commute, followed by a workday evening. Note that the predetermined period of time, for which the recorded time occupied by the user is according to the various time segments each day, may be expanded to additional days, weeks, months, etc.

Referring to FIG. 4B, shown is a graphic 86, which includes an activity performance scale 88 (y-axis, illustrating a step count for each of the time segments shown in FIG. 4A), a day scale 90 (x-axis, as similarly described in FIG. 4A), and a legend 92. Recorded data representations 94 (again in columnar format in this example) reveal the step count each day for each time segment of user behavior (e.g., step count for workday morning, step count for commute, etc.). In other words, the step counts are plotted in the same segmentations as shown in FIG. 4A. Note that, although the physical activity of walking is recorded, in some embodiments, other types and/or additional types of physical activity may be recorded and optionally presented. From the graphic 86, it is evident that the subject is reasonably inactive on weekends, with opportunities to improve on weekdays, especially Wednesdays. As noted in the graphic 86, for Sundays, beginning from the bottom of the columns of data 94, steps counts are recorded for the free day morning followed by the day time, and then the free day evening. For Monday through Friday, steps counts are recorded for the workday morning, followed consecutively by commute, at work, commute, and workday evening. For Saturday, steps counts are recorded for day time followed by the free day evening.

The application software 52 (e.g., the LM module 56, FIG. 3A) determines the costs for additional walking in different days and segments. For example, the simulation of this example is to be based on the costs (e.g., referred to herein also as Personal Cost Units (PCU)), which are listed in graphic 96, as shown in FIG. 4C. The graphic 96 illustrates the type of behavior of the subject for the various time segments 98, as previously shown in and described for FIGS. 4A-4B, and the PCUs 100 for each time segment. As revealed from the PCUs 100 shown in the graphic 96 of FIG. 4C, additional activity is most convenient in this example for the time segment with the lowest PCU (e.g., free day evening at 0.2 PCU), and least convenient for the time segment with the highest PCU (e.g., at work at 4.0 PCU), with variations in between for the other time segments.

The application software 52 (e.g., the DS/PMS module 58, FIG. 3A) simulates the changes in the parameters of the user using one of a plurality of computational models. For instance, and using the Hall model described previously, the DS/PMS module 58 calibrates the model using the activity data and weight measurements recorded from the past (e.g., a predetermined look-back period) of the user, and generates a clean baseline simulation 102 as shown in FIG. 5A for a projected period of time (e.g., twelve (12) weeks in this example). The baseline simulation 102 determines step counts in different segments, as shown in top graphic 104, and further predicts or forecasts a change in a physiological parameter, such as weight change, beginning with a starting value of ninety-eight (98) kilograms (kg) in this example (shown in middle graphic 106). Due to the calibration, there is only a very small drift in the weight estimate over time. The daily sums of costs are also determined, as shown in lower graphic 108. Note that the simulation 102 and associated data presented in graphics 104, 106, and 108 may merely be representative of the underlying processing of the application software, and in some embodiments, may also be presented to the user or others (e.g., via CN module 60, FIG. 3A, presenting a web page or other type of interface).

FIGS. 5B-5D illustrate the underlying processing and feedback provided by the computing device 36 (FIG. 3A) based on simulated scenarios. For instance, the application software 52 (FIG. 3A, including the DS/PMS module 58 for simulations and feedback via the CN module 60), executes several simulated interventions. The results of various twelve (12) week simulations are shown in FIGS. 5B-5D. Each of the FIGS. 5B-5D show a simulation intervention 110 (e.g., 110A, 110B, 110C for FIGS. 5B, 5C, and 5D, respectively), with a top graphic 112 (e.g., 112A, 112B, 112C for FIGS. 5B, 5C, and 5D, respectively), a middle graphic 114 (e.g., 114A, 114B, 114C for FIGS. 5B, 5C, and 5D, respectively), and a lower graphic 116 (e.g., 116A, 116B, 116C for FIGS. 5B, 5C, and 5D, respectively) for respective interventions (e.g., modification in the baseline simulation using additional physical activity, such as added steps), a change in the monitored physiological parameter (e.g., body weight in this example, in kilograms), and a total and unit (e.g., per equivalent minute) cost. For the example scenario corresponding to simulation intervention 110A of FIG. 5B, the top graphic 112A shows an extra thirty (30) minutes of walking in the time segment of working hours, which results in a forecasted weight decrease of 0.6 kg as shown in the middle graphic 114A at a total cost of 7200 PCUs as shown in the lower graphic 116A. For the example scenario corresponding to simulation intervention 110B of FIG. 5C, the top graphic 112B shows an extra forty-five (45) minutes of walking every second evening, which results in a forecasted weight decrease of 0.7 kg as shown in the middle graphic 114B at a total cost of 864 PCUs as shown in the lower graphic 116B. For the example scenario corresponding to simulation intervention 110C of FIG. 5D, the top graphic 112C shows a hybrid intervention comprising alternative active weeks and evening walks, which results in a forecasted weight decrease of 1.3 kg as shown in the middle graphic 114C at a total cost of 3424 PCUs as shown in the lower graphic 116C. In comparing the simulation interventions 110A and 110B of respective FIGS. 5B and 5C, the simulation intervention 110B has a significantly lower personal cost (e.g., 864 PCU versus 7200) for the user and at the same time a higher benefit (e.g., −0.7 kg versus −0.6 kg) than the intervention simulation 110A. Furthermore, the simulation intervention 110C of FIG. 5D illustrates an example of a relatively complex intervention consisting of monthly activity weeks, and an alternating pattern of evening walks, which is forecasted as a potentially efficient and relatively low-cost program for this individual. Note that any one or more of the graphics and associated data of FIGS. 5A-5D (and FIGS. 4A-4C) may be presented in whole or in part, or in a different manner or format, as feedback to the user or other party. In some embodiments, the information conveyed by the graphics of these figures may be presented at least in part as an aural communication in combination with or in lieu of the visual representations.

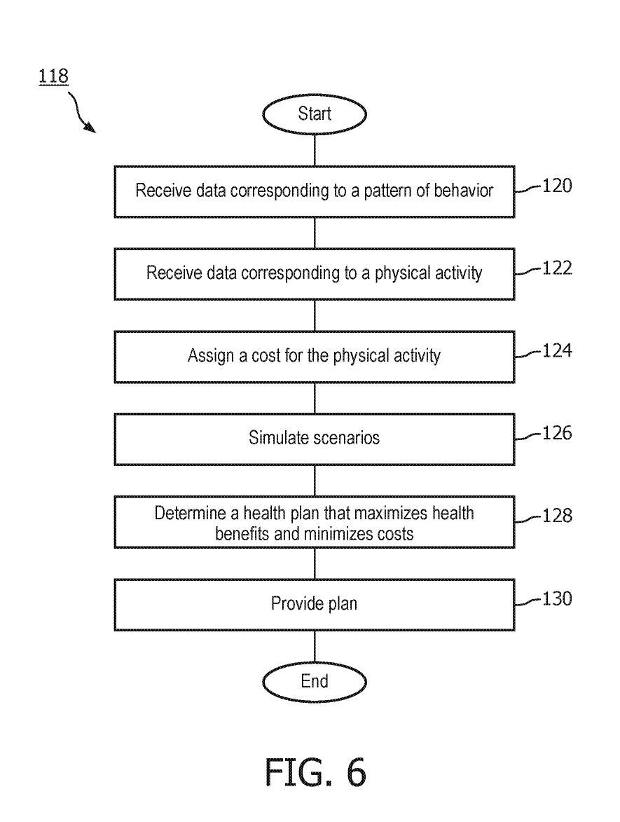

In view of the description above, it should be appreciated that one embodiment of a health coaching method, depicted in FIG. 6 and referred to as a method 118 and encompassed between start and end designations, comprises receiving data corresponding to a pattern of behavior (120), receiving data corresponding to a physical activity (122), assigning a cost of the physical activity (124), simulating scenarios (126), determining a health plan that maximizes health benefits and minimizes costs (128), and providing the plan (1308). For instance, the method 118 receives the data, for each day over a predetermined period of time, corresponding to the pattern of behavior of a subject, wherein the pattern of behavior for each day is divided into plural types of behavior defined by respective plural time segments, wherein the pattern of behavior for one of the days is different than the pattern of behavior for another of the days. The data may be raw data from the wearable device 12 (FIG. 1), such as via electronics devices 14, 16, and arranged in a data structure by the processing circuit 37 (FIG. 3A). In some embodiments, the raw data may be received at another device (e.g., the electronics devices or other network-connected devices), arranged in a data structure, and provided to the processing circuit 37. In other words, functionality of all or a portion of the LM module 56 (FIG. 3A) may be local to the processing circuit 37 in some embodiments, or located elsewhere in some embodiments. The data need not actually be received daily, but rather, may be received periodically or aperiodically, the data representing the daily pattern of behavior. The method 118 further comprises receiving data corresponding to a physical activity for each of the plural time segments, and assigns a cost for the physical activity for each of the plural time segments, each cost corresponding to a relative convenience for the subject to perform the physical activity during the respective time segment. In some embodiments, the assigning of costs may be implemented in the processing circuit 37, or in a device external to the processing circuit 37 and provided to the processing circuit 37. The method 118 determines a health plan for a projected period of time by simulating a plurality of scenarios corresponding to a modification of the physical activity using the pattern of behavior of the predetermined period of time with adjustments to a duration of one or more of the plural time segments, the health plan corresponding to a series of forecasted measurements of a physiological parameter that minimizes a total cost for the physical activity while maximizing a health benefit associated with the physiological parameter. The method 118 provides feedback of the determined health plan.

Any process descriptions or blocks in the flow diagram of FIG. 6 should be understood as representing modules, segments, or portions of code which include one or more executable instructions for implementing specific logical functions or steps in the process, and alternate implementations are included within the scope of an embodiment of the present invention in which functions may be executed substantially concurrently, and/or additional logical functions or steps may be added, depending on the functionality involved, as would be understood by those reasonably skilled in the art of the present invention.

In one embodiment, a claim to an apparatus is disclosed, comprising: a processing circuit configured to: receive data, for each day over a predetermined period of time, corresponding to a pattern of behavior of a subject, wherein the pattern of behavior for each day is divided into plural types of behavior defined by respective plural time segments, wherein the pattern of behavior for one of the days is different than the pattern of behavior for another of the days; receive data corresponding to a physical activity for each of the plural time segments; assign a cost for the physical activity for each of the plural time segments, each cost corresponding to a relative convenience for the subject to perform the physical activity during the respective time segment; determine a health plan for a projected period of time by simulating a plurality of scenarios corresponding to a modification of the physical activity using the pattern of behavior of the predetermined period of time with adjustments to a duration of one or more of the plural time segments, the health plan corresponding to a series of forecasted measurements of a physiological parameter that minimizes a total cost for the physical activity while maximizing a health benefit associated with the physiological parameter; and provide feedback of the determined health plan.

The apparatus of the prior claim, wherein the processing circuit is further configured to determine the health plan by: determining a physical activity energy expenditure for each day of the predetermined period of time based on the physical activity; estimating a time series of expected measurements of the physiological parameter for the projected period of time based on a total energy expenditure determined from the physical activity energy expenditure and nutritional intake, the projected period of time using the pattern of behavior of the predetermined period of time; re-computing the total energy expenditure and a revised cost for the physical activity for each day of the projected time period using the plural simulated scenarios that modify the pattern of behavior of the predetermined period of time with additional periods of the physical activity; and estimating the time series of forecasted measurements of the physiological parameter for the projected period of time based on the re-computed total energy expenditures and the revised costs.

The apparatus of any one of the preceding claims, wherein the processing circuit is configured to establish one or more profiles corresponding to the pattern of behavior over the predetermined period of time, the plurality of profiles established for one or any combination of a work day, a weekend, a free day, and for each weekday.

The apparatus of any one of the preceding claims, wherein the plural types of behavior comprise one or any combination of a sleep behavior, a morning behavior, a first commute behavior, a work behavior, a second commute behavior, and an evening behavior.

The apparatus of any one of the preceding claims, wherein the processing circuit determines a transition between each time segment of the plural time segments based on location data, activity data, or a combination of the location and the activity data.

The apparatus of any one of the preceding claims, wherein each of the costs are pre-defined, estimated from responses from the subject, based on a questionnaire or interview of the subject, or based on any combination of the predefinition, responses, questionnaire or interview.

The apparatus of any one of the preceding claims, wherein the forecasted measurements are based on one or any combination of weight, height, age, and gender of the subject.

The apparatus of any one of the preceding claim 1, wherein the time series of the expected and forecasted measurements comprise weight estimates or body fat percentage estimates as a function of day count.

The apparatus of any one of the preceding claims, wherein the processing circuit determines the health plan by comparing the series of forecasted measurements and the associated total costs for each of the estimated time series of forecasted measurements.

The apparatus of any one of the preceding claims, wherein the processing circuit is configured to provide feedback by causing a visual presentation to the subject, to a third party, or to a combination of the subject and the third party.

The apparatus of any one of the preceding claims, wherein the processing circuit is configured to determine additional health plans as well as the health plan as options for selection, the additional health plans corresponding to the series of forecasted measurements of the physiological parameter that minimizes the total cost for the physical activity while maximizing the health benefit associated with the physiological parameter.

The apparatus of any one of the preceding claims, wherein the processing circuit is configured to receive data corresponding to plural physical activities that include the physical activity and based on the plural physical activities, repeat the assigning and the determining.

The apparatus of any one of the preceding claims, wherein the feedback comprises a trajectory of values for the physiological parameter and associated cost over the projected period of time.

In one embodiment, a claim to a method is disclosed, comprising: receiving data, for each day over a predetermined period of time, of a pattern of behavior of a subject, wherein the pattern of behavior for each day is divided into plural types of behavior defined by respective plural time segments, wherein the pattern of behavior for one of the days is different than the pattern of behavior for another of the days; receiving data corresponding to a physical activity for each of the plural time segments; assigning a cost for the physical activity for each of the plural time segments, each cost corresponding to a relative convenience for the subject to perform the physical activity during the respective time segment; determining a health plan for a projected period of time by simulating a plurality of scenarios corresponding to a modification of the physical activity using the pattern of behavior of the predetermined period of time with adjustments to a duration of one or more of the plural time segments, the health plan corresponding to a series of forecasted measurements of a physiological parameter that minimizes a total cost for the physical activity while maximizing a health benefit associated with the physiological parameter; and providing feedback of the determined health plan.

The method of the immediately prior claim, wherein the determining further comprises: determining a physical activity energy expenditure for each day of the predetermined period of time based on the physical activity; estimating a time series of expected measurements of the physiological parameter for the projected period of time based on a total energy expenditure determined from the physical activity energy expenditure and nutritional intake, the projected period of time using the pattern of behavior of the predetermined period of time; re-computing the total energy expenditure and a revised cost for the physical activity for each day of the projected time period using the plural simulated scenarios that modify the pattern of behavior of the predetermined period of time with additional periods of the physical activity; and estimating the time series of forecasted measurements of the physiological parameter for the projected period of time based on the re-computed total energy expenditures and the revised costs.

In one embodiment, a claim to a computer readable medium is disclosed, the computer readable medium encoded with instructions executable by a processing circuit that causes the processing circuit to: receive data, for each day over a predetermined period of time, corresponding to a pattern of behavior of a subject, wherein the pattern of behavior for each day is divided into plural types of behavior defined by respective plural time segments, wherein the pattern of behavior for one of the days is different than the pattern of behavior for another of the days; receive data corresponding to a physical activity for each of the plural time segments; assign a cost for the physical activity for each of the plural time segments, each cost corresponding to a relative convenience for the subject to perform the physical activity during the respective time segment; determine a health plan for a projected period of time by simulating a plurality of scenarios corresponding to a modification of the physical activity using the pattern of behavior of the predetermined period of time with adjustments to a duration of one or more of the plural time segments, the health plan corresponding to a series of forecasted measurements of a physiological parameter that minimizes a total cost for the physical activity while maximizing a health benefit associated with the physiological parameter; and provide feedback (110) of the determined health plan.

While the invention has been illustrated and described in detail in the drawings and foregoing description, such illustration and description are to be considered illustrative or exemplary and not restrictive; the invention is not limited to the disclosed embodiments. For example, as described previously, though the physical activity used in the aforementioned examples comprises walking, other and/or additional types of activity may be used in the determination of costs and/or baseline and scenarios. Also, alternative base and range of costs may be used compared to those used in the aforementioned examples, and different and/or additional physiological parameters may be recorded. As another example of variations contemplated to be within the scope of the disclosure, although the health coaching system described herein has been described using a process that maps steps during walking to energy expenditures, the methods described herein may be used for other activities such as sleep behavior (e.g., to assess how well a subject sleeps and what interventions may be used to improve sleeping behavior), various health-related conditions (e.g., to forecast results and provide concrete steps in reducing blood pressure, diabetes, other ailments) or fitness (e.g., VO2 max, recovery, etc.). Note that where multiple changes are needed as part of the health plan or program, the costs and benefits for a multiple change program may be compared. Other variations to the disclosed embodiments can be understood and effected by those skilled in the art in practicing the claimed invention, from a study of the drawings, the disclosure, and the appended claims. Note that various combinations of the disclosed embodiments may be used, and hence reference to an embodiment or one embodiment is not meant to exclude features from that embodiment from use with features from other embodiments. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical medium or solid-state medium supplied together with or as part of other hardware, but may also be distributed in other forms. Any reference signs in the claims should be not construed as limiting the scope.

At least the following is claimed:

1. An apparatus, comprising:
a processing circuit configured to:
receive data, for each day over a predetermined period of time, corresponding to a pattern of behavior of a subject, wherein the pattern of behavior for each day is divided into plural types of behavior defined by respective plural time segments, wherein the pattern of behavior for one of the days is different than the pattern of behavior for another of the days;
receive data corresponding to a physical activity for each of the plural time segments;
assign a cost for the physical activity for each of the plural time segments, each cost corresponding to a relative convenience for the subject to perform the physical activity during the respective time segment;
determine a health plan for a projected period of time by simulating a plurality of scenarios corresponding to a modification of the physical activity using the pattern of behavior of the predetermined period of time with adjustments to a duration of one or more of the plural time segments, the health plan corresponding to a series of forecasted measurements of a physiological parameter that minimizes a total cost for the physical activity while maximizing a health benefit associated with the physiological parameter; and
provide feedback of the determined health plan.

2. The apparatus of claim 1, wherein the processing circuit is further configured to determine the health plan by:
determining a physical activity energy expenditure for each day of the predetermined period of time based on the physical activity;
estimating a time series of expected measurements of the physiological parameter for the projected period of time based on a total energy expenditure determined from the physical activity energy expenditure and nutritional intake, the projected period of time using the pattern of behavior of the predetermined period of time;
re-computing the total energy expenditure and a revised cost for the physical activity for each day of the projected time period using the plural simulated scenarios that modify the pattern of behavior of the predetermined period of time with additional periods of the physical activity; and
estimating the time series of forecasted measurements of the physiological parameter for the projected period of time based on the re-computed total energy expenditures and the revised costs.

3. The apparatus of claim 1, wherein the processing circuit is configured to establish one or more profiles corresponding to the pattern of behavior over the predetermined period of time, the plurality of profiles established for one or any combination of a work day, a weekend, a free day, and for each weekday.

4. The apparatus of claim 1, wherein the plural types of behavior comprise one or any combination of a sleep behavior, a morning behavior, a first commute behavior, a work behavior, a second commute behavior, and an evening behavior.

5. The apparatus of claim 1, wherein the processing circuit determines a transition between each time segment of the plural time segments based on location data, activity data, or a combination of the location and the activity data.

6. The apparatus of claim 1, wherein each of the costs are pre-defined, estimated from responses from the subject, based on a questionnaire or interview of the subject, or based on any combination of the predefinition, responses, questionnaire or interview.

7. The apparatus of claim 1, wherein the forecasted measurements are based on one or any combination of weight, height, age, and gender of the subject.

8. The apparatus of claim 1, wherein the time series of the expected and forecasted measurements comprise weight estimates or body fat percentage estimates as a function of day count.

9. The apparatus of claim 1, wherein the processing circuit determines the health plan by comparing the series of forecasted measurements and the associated total costs for each of the estimated time series of forecasted measurements.

10. The apparatus of claim 1, wherein the processing circuit is configured to provide feedback by causing a visual presentation to the subject, to a third party, or to a combination of the subject and the third party.

11. The apparatus of claim 1, wherein the processing circuit is configured to determine additional health plans as well as the health plan as options for selection, the additional health plans corresponding to the series of forecasted measurements of the physiological parameter that minimizes the total cost for the physical activity while maximizing the health benefit associated with the physiological parameter.

12. The apparatus of claim 1, wherein the processing circuit is configured to receive data corresponding to plural physical activities that include the physical activity and based on the plural physical activities, repeat the assigning and the determining.

13. The apparatus of claim 1, wherein the feedback comprises a trajectory of values for the physiological parameter and associated cost over the projected period of time.

14. A method, comprising:
receiving data, for each day over a predetermined period of time, corresponding to a pattern of behavior of a subject, wherein the pattern of behavior for each day is divided into plural types of behavior defined by respective plural time segments, wherein the pattern of behavior for one of the days is different than the pattern of behavior for another of the days;
receiving data corresponding to a physical activity for each of the plural time segments;
assigning a cost for the physical activity for each of the plural time segments, each cost corresponding to a relative convenience for the subject to perform the physical activity during the respective time segment;
determining a health plan for a projected period of time by simulating a plurality of scenarios corresponding to a modification of the physical activity using the pattern of behavior of the predetermined period of time with adjustments to a duration of one or more of the plural time segments, the health plan corresponding to a series of forecasted measurements of a physiological parameter that minimizes a total cost for the physical activity while maximizing a health benefit associated with the physiological parameter; and
providing feedback of the determined health plan.

15. The method of claim 14, wherein the determining further comprises:
determining a physical activity energy expenditure for each day of the predetermined period of time based on the physical activity;
estimating a time series of expected measurements of the physiological parameter for the projected period of time based on a total energy expenditure determined from the physical activity energy expenditure and nutritional intake, the projected period of time using the pattern of behavior of the predetermined period of time;
re-computing the total energy expenditure and a revised cost for the physical activity for each day of the projected time period using the plural simulated scenarios that modify the pattern of behavior of the predetermined period of time with additional periods of the physical activity; and
estimating the time series of forecasted measurements of the physiological parameter for the projected period of time based on the re-computed total energy expenditures and the revised costs.

16. A computer readable medium encoded with instructions executable by a processing circuit that causes the processing circuit to:
receive data, for each day over a predetermined period of time, corresponding to a pattern of behavior of a subject, wherein the pattern of behavior for each day is divided into plural types of behavior defined by respective plural time segments, wherein the pattern of behavior for one of the days is different than the pattern of behavior for another of the days;
receive data corresponding to a physical activity for each of the plural time segments;
assign a cost for the physical activity for each of the plural time segments, each cost corresponding to a relative convenience for the subject to perform the physical activity during the respective time segment;
determine a health plan for a projected period of time by simulating a plurality of scenarios corresponding to a modification of the physical activity using the pattern of behavior of the predetermined period of time with adjustments to a duration of one or more of the plural time segments, the health plan corresponding to a series of forecasted measurements of a physiological parameter that minimizes a total cost for the physical activity while maximizing a health benefit associated with the physiological parameter; and
provide feedback of the determined health plan.
